(19) United States
(12) Patent Application Publication
(10) Pub. No.: US 2011/0144234 A1
(43) Pub. Date: Jun. 16, 2011

(54) RUBBER COMPOSITION

(75) Inventor: Naoki Inui, Yamatokoriyama-shi (JP)

(73) Assignee: SUMITOMO CHEMICAL COMPANY, LIMITED, Tokyo (JP)

(21) Appl. No.: 12/995,907

(22) PCT Filed: Jun. 2, 2009
(86) PCT No.: PCT/JP2009/060414

§ 371 Date: Jan. 6, 2011

(30) Foreign Application Priority Data
Jun. 4, 2008 (JP) 2008-146613

(51) Int. Cl. C08K 5/3492; C08L 7/00

(52) U.S. Cl. 523/156; 524/101

(57) ABSTRACT

A rubber composition comprising:
(A) 100 parts by weight of a rubber component mainly containing at least one rubber selected from the group consisting of natural rubber and/or isoprene rubber,
(B) 0.5 to 3 parts by weight of a condensation product of resorcin and a ketone, and
(C) 0.5 to 2 parts by weight of a condensation product of melamine, formaldehyde and methanol wherein the ratio of methylol groups to melamine structures is 0.35 to 0.55 and the average degree of polymerization is 1.2 to 1.6.

### FIELD OF THE INVENTION

The present invention relates to a rubber composition.

### BACKGROUND OF THE INVENTION

JP S58-147444 A1 discloses a rubber composition comprising a vulcanizable natural rubber or synthetic rubber, 2,4,4-trimethyl-2′,4′,7-trihydroxyflavan which is a compound obtainable by a condensation reaction of resorcin and acetone or the like, and a compound capable of giving a methylene group on heating (for example, hexamethylenetetramine, poly(methylol)melamine derivative or the like).

### DISCLOSURE OF THE INVENTION

The present invention provides:

### <1> A Rubber Composition Comprising:

(A) 100 parts by weight of a rubber component mainly containing at least one rubber selected from the group consisting of natural rubber and/or isoprene rubber,

(B) 0.5 to 3 parts by weight of a condensation product of resorcin and a ketone, and

(C) 0.5 to 2 parts by weight of a condensation product of melamine, formaldehyde and methanol wherein the ratio of methylol groups to melamine structures is 0.35 to 0.55 and the average degree of polymerization is 1.2 to 1.6;

<2> The rubber composition according to <1>, wherein the ketone of the condensation product of resorcin and a ketone is acetone;
<3> The rubber composition according to <1> or <2>, wherein the ratio of methoxy groups to melamine structures of the condensation product of melamine, formaldehyde and methanol is 4.3 to 4.9;
<4> The rubber composition according to any of <1> to <3>, which further comprises 5 to 15 parts by weight of hydrous silica and 45 to 60 parts by weight of carbon black per 100 parts by weight of the rubber component (A);
<5> A belt comprising a steel cord coated with the rubber composition according to any of <1> to <4>;
<6> A carcass comprising a carcass fiber cord covered with the rubber composition according to any of <1> to <4>;
<7> A captread or undertread comprising the rubber composition according to any of <1> to <4>;
<8> A pneumatic tire produced by using the rubber composition according to any of <1> to <4>.

### BEST MODES FOR CARRYING OUT THE INVENTION

The present invention will be illustrated in detail below.

The rubber composition of the present invention comprises

(A) 100 parts by weight of a rubber component mainly containing at least one rubber selected from the group consisting of natural rubber and/or isoprene rubber (hereinafter, simply referred to as Component A),

(B) 0.5 to 3 parts by weight of a condensation product of resorcin and a ketone (hereinafter, simply referred to as Component B), and

(C) 0.5 to 2 parts by weight of a condensation product of melamine, formaldehyde and methanol wherein the ratio of methylol groups to melamine structures is 0.35 to 0.55 and the average degree of polymerization is 1.2 to 1.6 (hereinafter, simply referred to as Component C).

Examples of Component A include those containing at least one rubber selected from the group consisting of natural rubber and isoprene rubber in 50% by weight or more.

Component A may contain rubber components other than at least one rubber selected from the group consisting of natural rubber and isoprene rubber, and specific examples of the rubber components other than the above-mentioned rubber include butadiene rubber and styrene-butadiene copolymerized rubber.

As natural rubber and isoprene rubber, commercially available one may be used, and one produced according to known methods may be used. As the rubber components other than the above-mentioned rubber, commercially available one may be also used, and one produced according to known methods may be also used.

Examples of Component B include a condensation product of resorcin and a ketone having 3 to 6 carbon atoms. Specific examples thereof include a condensation product of resorcin and acetone, a condensation product of resorcin and methyl ethyl ketone, a condensation product of resorcin and diethyl ketone, a condensation product of resorcin and methyl isopropyl ketone, a condensation product of resorcin and methyl butyl ketone and a condensation product of resorcin and cyclohexanone. Among them, preferred is a condensation product of resorcin and acetone in the viewpoint of a performance and an availability of law materials.

Among the condensation products of resorcin and acetone, especially, preferred is one containing 2,4,4-trimethyl-2′,4′,7-trihydroxyflavan represented by the following formula:

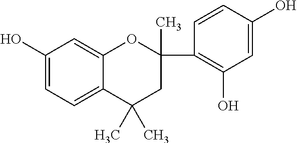

in 30% by weight or more in performance, and more preferred is one containing it in 50% by weight or more. The condensation product of resorcin and a ketone can be produced by conducting a condensation reaction of resorcin and the ketone in the presence of an acid catalyst such as hydrochloric acid according to the methods described in GB Patent No. 1,032,055, U.S. Pat. No. 3,281,311 or the like.

The amount of Component B to be blended is 0.5 to 3 parts by weight per 100 parts of Component A, and preferably 1 to 2 parts by weight.

Component C is a condensation product of melamine, formaldehyde and methanol wherein the ratio of methylol groups to melamine structures is 0.35 to 0.55 and the average degree of polymerization is 1.2 to 1.6. A condensation product wherein the ratio of methoxy groups to melamine structures is 4.3 to 4.9 is preferable. The amount of Component C to be blended is 0.5 to 2 parts by weight per 100 parts of Component A, and preferably 0.5 to 1 part by weight.

Component C is produced, for example, by a methylol step of conducting a condensation reaction in the presence of an acid catalyst such as sulfuric acid, p-toluenesulfonic acid and hydrochloric acid by mixing 6 to 9 moles of methanol and 9.7 to 11 moles of paraformaldehyde to 1 mole of melamine to obtain a methylol condensation product, and conducting a condensation reaction in the presence of an acid catalyst such as sulfuric acid, p-toluenesulfonic acid and hydrochloric acid by mixing the methylol condensation product obtained with 14 to 20 moles of methanol per 1 mole of melamine used in the previous step.

The rubber composition of the present invention can further contain reinforcing agents and/or fillers, as necessary. As the reinforcing agents and fillers, those usually used in the rubber industry can be used. Specific examples thereof include reinforcing agents such as carbon black, and inorganic fillers such as silica, clay and calcium carbonate. Among them, preferred is blending of carbon black from the viewpoint of reinforcibility, and those usually used in the rubber industry, for example, SAF, ISAF, HAF, FEF, SRF, GPF and MT, can be used. Especially, from the viewpoint of heat build-up, HAF, FEF and SRF are preferably used. The amount of the reinforcing agents and/or fillers, especially carbon black, to be blended is preferably in the range of about 10 to 80 parts by weight per 100 parts by weight of Component A from the viewpoint of heat build-up and dynamic magnification, and is more preferably in the range of about 45 to 60 parts by weight.

The rubber composition of the present invention preferably also contains hydrous silica aside from carbon black or together with carbon black. When hydrous silica is used, the amount of hydrous silica to be blended is preferably in the range of 5 to 15 parts by weight per 100 parts by weight of Component A.

The rubber composition of the present invention may contain one or more kinds of various rubber chemicals usually used in the rubber industry, for example, age resisters such as antioxidants and antiozonants, vulcanization agents, cross-linking agents, vulcanization accelerators, retarders, peptizers, processing aids, waxes, oils, stearic acid and tackifiers, as necessary. While the amount of these rubber chemicals to be blended varies depending on their intended use, it can be used in a range in which they each are usually used in the rubber industry.

The rubber composition of the present invention can be led, for example, to rubber products having a good processability on producing the rubber products such as improvement of scorching resistance, and a good dynamic viscoelasticity such as reduction of loss factor via steps such as molding and vulcanization according to methods usually conducted in the rubber fields. Especially, it exhibits superior effects when it is used for various tire components such as captread, undertread, belt, carcass, bead, sidewall and rubber chafer. Alternatively, it also exhibits superior effects when it is used for antivibration rubbers for cars such as engine mount, strut mount, bush and exhaust hanger, hoses, rubber belts and the like.

For example, the belt of the present invention can be produced by coating steel cords with the rubber composition of the present invention. The steel cords are usually used in the form of being parallel aligned by pulling.

It is preferred that steel cords are plated with brass, zinc or alloy containing it and nickel or cobalt from the viewpoint of adhesiveness to rubbers, and those plated with brass are especially preferable. Especially, steel cords plated with brass wherein the content percentage of Cu in the brass-plating is 75% by mass or less, and preferably 55 to 70% by mass are preferable. The twist structure of steel cords is not limited.

The plural belts of the present invention may be layered to be used. The belts of the present invention are used as tire reinforcing materials such as belt layers, reinforcing layers of bead portions, sidewall reinforcing layers and carcass.

Alternatively, for example, carcass can be produced by conducting extruding processing of the rubber composition of the present invention to fit on the carcass shape of the tire followed by applying it up and down carcass fiber cord. The carcass fiber cords are usually used in the form of being parallel aligned by pulling. As carcass fiber cords, polyesters which are good in elastic modulus and resistance to fatigue, are excellent in creep resistance and are inexpensive are preferable. These are used as reinforcing materials for tires in a single or by layering plural thereof.

The pneumatic tire of the present invention is produced by using the rubber composition of the present invention according to conventional process for producing a pneumatic tire. For example, the extruding processing of the rubber composition of the present invention is conducted to obtain a member for tire and then, it is applied and molded to other tire member or members on a tire molding machine according to conventional methods to be molded to an unvulcanized tire. This unvulcanized tire is heated and pressurized in a vulcanizer to obtain a tire.

### EXAMPLES

The present invention will be illustrated in more detail by Examples bellow, but the present invention is not limited to these Examples.

### Reference Example 1

### Process for Producing Component B

Into a 200 mL four-necked flask equipped with a thermometer, a stirrer and a condenser, 37.9 g of resorcin was added. After substituting to nitrogen in the flask, 21.9 g of acetone and 69.0 g of toluene were added thereto. The obtained mixture was heated up to 40° C. to perfectly dissolve resorcin therein. The obtained solution was heated up to 75° C., and then, 5.1 g of 2,4,4-trimethyl-2′, 4′, 7-trihydroxyflavan was added thereto. Further, 0.33 g of 96% sulfuric acid was added thereto, and the obtained mixture was kept at an inner temperature of 76 to 78° C. for 11 hours. After completion of the reaction, the reaction mixture was cooled down to room temperature, and then, was washed with water. The obtained mixture was dried under reduced pressure to obtain a resinous condensation product of resorcin and acetone (hereinafter, simply referred to as B1). The melting point of B1 was beginning of melting of 121° C. and ending of melting of 134° C. Alternatively, the composition of B1 was as followed.

2,4,4-trimethyl-2′,4′,7-trihydroxyflavan: 76.1% resorcin: 0.5%

### Reference Example 2

### Process for Producing Component C

Into a 1 L four-necked flask equipped with a thermometer, a stirrer and a condenser, 190.5 g of methanol (7.5 moles per 1 mole of melamine) and 270.6 g of 88% paraformaldehyde (10.0 moles per 1 mole of melamine) were added under an atmosphere of nitrogen at room temperature with stirring. The obtained mixture was heated up to 65° C., and then, the obtained solution was cooled down to 50° C. To the solution, 0.06 mL of 71% by weight sulfuric acid was added, and 100.0 g of melamine was further added thereto. The obtained mixture was heated up to 85 to 88° C., and was kept at the same temperature for 1.5 hours. The reaction mixture was cooled down to 50° C., and then, was neutralized by adding 0.28 mL of 28% sodium hydroxide. The inner pressure of the flask was adjusted at 700 mmHg, and the fraction was distilled away from the obtained mixture with heating until 60° C., and then, the inner pressure of the flask was returned back to a normal pressure and the concentrated residue was cooled down to 50° C. To the concentrated residue, 431.9 g of methanol (17.0 moles per 1 mole of melamine) was added at the same temperature. The obtained mixture was cooled down to 25° C., and 8.2 mL of 71% sulfuric acid was added thereto to keep at 30° C. for 1 hour. After adjusting to pH 10 with 28% sodium hydroxide, the fraction was distilled away from the mixture at 700 mmHg with heating until 115° C. By returning the inner pressure of the flask back to a normal pressure and cooling down to 25° C., 279.4 g of the condensation product of melamine, formaldehyde and methanol (hereinafter, simply referred to as C1) was obtained.

The average degree of polymerization, the ratio of methylol groups to melamine structures and the ratio of methoxy groups to melamine structures of C1 were measured according to the following methods, respectively. The results are shown in Table 1.

### <Average Degree of Polymerization>

Gel permeation chromatography analysis is conducted according to the analytical condition showed below to evaluate area percentages of a condensation product having one melamine structure (hereinafter, simply referred to as mononuclear form), a condensation product having two melamine structures (hereinafter, simply referred to as dinuclear form) and a condensation product having three melamine structures (hereinafter, simply referred to as trinuclear form) in the condensation product, respectively. Each molar fraction is calculated based on each area percentage according to the following formula.

Molar fraction of mononuclear form(M⁴)=(peak area of mononuclear form)/(sum of peak areas of all the components)

Molar fraction of dinuclear form(M⁵)=(peak area of dinuclear form)/{(sum of peak areas of all the components)×2}

Molar fraction of trinuclear form(M⁶)=(peak area of trinuclear form)/{(sum of peak areas of all the components)×3}

The average degree of polymerization is calculated based on the molar fractions obtained according to the following formula.

Average degree of polymerization=100/(M⁴+M⁵/2+M⁶/3)

### <Analytical Condition>

Apparatus: LC-3A manufactured by SHIMADZU CORPORATION
Column: Shodex KF-803 (8 mmφ×30 cm), Shodex KF-802 (8 mmφ×30 cm) and Shodex KF-801 (8 mmφ×30 cm) were joined.
Mobile phase: tetrahydrofuran
Flow rate: 1.0 mL/min.

### Detector: UV

### <Ratio of Methylol Groups to Melamine Structures and Ratio of Methoxy Groups to Melamine Structures>

(1) An aqueous formaldehyde solution is obtained by a steam distillation of the condensation product. To the aqueous formaldehyde solution obtained, an excess amount of iodine is added to react formaldehyde with iodine. The residual iodine in the reaction solution is titrated with sodium thiosulfate to evaluate the content of total formaldehyde (%) (hereinafter, simply referred to as X²).
(2) An excess amount of sodium sulfite is added to the condensation product to react free formaldehyde with sodium sulfite. A neutralizing titration of sodium hydroxide generated with hydrochloric acid is conducted to evaluate the content of free formaldehyde (%) (hereinafter, simply referred to as X³).
(3) An excess amount of iodine is added to the condensation product to react methylol groups of the condensation product and free formaldehyde with iodine. The residual iodine in the reaction solution is titrated with sodium thiosulfate to evaluate sum of amounts of methylol groups and free formaldehyde followed by subtracting the free formaldehyde (%) obtained in (2) therefrom to calculate the content of methylol groups (%) (hereinafter, simply referred to as X⁴).
(4) The elemental analysis of the condensation product is carried out, and based on the content of nitrogen (% by weight), molar fraction of melamine in the condensation product (hereinafter, simply referred to as M¹) is calculated according to the following formula.

M¹=Content of nitrogen/(14.01×6)

(5) The molar fraction of methylol groups (hereinafter, simply referred to as M³) is calculated based on X⁴ obtained in (3) according to the following formula.

M³=X⁴/31.04

(6) The content of bonding formaldehyde (%) (hereinafter, simply referred to as X¹) is calculated according to the following formula, and molar fraction of bonding formaldehyde (hereinafter, simply referred to as M²) is calculated based on X¹ obtained according to the following formula.

X¹=X²−X³

M²=X¹/30.03

(7) The ratio of bonding formaldehyde to melamine structures (hereinafter, simply referred to as Y¹) is calculated according to the following formula.

Y¹=M²/M¹

(8) The ratio of methylol groups to melamine structures (hereinafter, simply referred to as Y²) is calculated according to the following formula.

Y²=M³/M¹

(9) The ratio of methylene groups to melamine structures (hereinafter, simply referred to as Y³) is calculated based on M⁵ and M⁶ obtained in the above-mentioned <Average degree of polymerization> according to the following formula.

Y³=M⁵+2×M⁶

(10) The ratio of methoxy groups to melamine structures (hereinafter, simply referred to as Y⁴) is calculated according to the following formula.

Y⁴=Y¹−(Y²+Y³)

### Comparative Reference Example 1

### Process for Producing Condensation Product of Melamine, Formaldehyde and Methanol Used in Comparative Example 1

Into a 1 L four-necked flask equipped with a thermometer, a stirrer and a condenser, 178 g of methanol (7.0 moles per 1 mole of melamine), 8.3 g of water, 0.05 mL of 28% by weight aqueous sodium hydroxide solution and 244.3 g of 88% paraformaldehyde (9.0 moles per 1 mole of melamine) were added under an atmosphere of nitrogen at room temperature with stirring. The obtained mixture was heated up to 65° C. to obtain a solution. The obtained solution was cooled down to 50° C., and then, 0.06 mL of 71% by weight sulfuric acid was added thereto, and 100.0 g of melamine and 3 g of methanol were further added thereto. The obtained mixture was kept at 85 to 88° C. for 1 hour. The reaction mixture obtained was cooled down to 50° C., and then, was neutralized by adding 0.27 mL of 28% sodium hydroxide. The inner pressure of the flask was adjusted at 700 mmHg, and the fraction was distilled away from the obtained mixture with heating until 60° C., and then, the inner pressure of the flask was returned back to a normal pressure and the concentrated residue was cooled down to 50° C. To the concentrated residue, 564.5 g of methanol (22.2 moles per 1 mole of melamine) was added at the same temperature to cool down to 25° C. To the mixture obtained, 8 mL of 71% sulfuric acid was added followed by keeping at 30° C. for 1 hour. The reaction mixture obtained was neutralized with 17.5 mL of 28% sodium hydroxide. The inner pressure of the flask was adjusted at 700 mmHg, and the fraction was distilled away from the mixture with heating until 115° C. After returning the inner pressure of the flask back to a normal pressure, cooling down to 25° C. was conducted to obtain 285.2 g of the condensation product of melamine, formaldehyde and methanol (hereinafter, simply referred to as C2).

The average degree of polymerization, the ratio of methylol groups to melamine structures (Y²) and the ratio of methoxy groups to melamine structures (Y⁴) of C2 were measured according to the methods described in the above-mentioned Reference Example 2. The results are shown in Table 1.

### Comparative Reference Example 2

### Process for Producing Condensation Product of Melamine, Formaldehyde and Methanol Used in Comparative Example 2

Into a 1 L four-necked flask equipped with a thermometer, a stirrer and a condenser, 206.4 mL of methanol (4.9 moles per 1 mole of melamine), 0.1 mL of 10N aqueous sodium hydroxide solution and 344 g of 88% paraformaldehyde (9.5 moles per 1 mole of melamine) were added under an atmosphere of nitrogen at room temperature with stirring. The obtained mixture was heated up to 65° C. to obtain a solution. The obtained solution was cooled down to 50° C., and then, 0.08 mL of 20N sulfuric acid was added thereto, and 130 g of melamine was further added thereto. The obtained mixture was kept at 85 to 88° C. for 1 hour. The reaction mixture obtained was cooled down to 60° C., and then, 412.9 mL of methanol (9.9 moles per 1 mole of melamine) and 0.3 mL of 20N sulfuric acid were added thereto. The obtained mixture was kept at 75° C. for 2 hours. 10N aqueous sodium hydroxide solution was added to the reaction mixture obtained to adjust to pH 10, and then, the inner pressure of the flask was gradually reduced until 60 mmHg, and the fraction was distilled away from the obtained mixture with heating until 120° C. The inner pressure of the flask was returned back to a normal pressure and the concentrated residue was cooled down to 25° C. to obtain 356.0 g of the condensation product of melamine, formaldehyde and methanol (hereinafter, simply referred to as C3).

The average degree of polymerization, the ratio of methylol groups to melamine structures (Y²) and the ratio of methoxy groups to melamine structures (Y⁴) of C3 were measured according to the methods described in the above-mentioned Reference Example 2. The results are shown in Table 1.

### Example 1 and Comparative Examples 1 to 4

A 1.8 L Banbury mixer was used and the initial temperature in the system was set at 140° C. 100 parts by weight of natural rubber (RSS #3) as Component A, 50 parts by weight of N285 carbon black, 10 parts by weight of hydrous silica (Nipsil AQ manufactured by Nihon Silica Kogyo, Co. Ltd.), 5 parts by weight of aromaoil, 1 parts by weight of stearic acid, 5 parts by weight of zinc oxide, 2 parts by weight of 2,2,4-trimethyl-1,2-dihydroxyquinoline polymer as the age resister and 1.5 parts by weight of B1 obtained in Reference Example 1 as Component B were added into the mixer followed by kneading for 3 minutes to obtain a rubber composition. Next, the rubber composition obtained was added again into the Banbury mixer, and the initial temperature in the system was set at 80° C., and 1.5 parts by weight of sulfur and 1.25 parts by weight of N,N-dicyclohexyl-2-benzothiazylsulfenamide as the vulcanization accelerator were added thereto and the condensation products of melamine, formaldehyde and methanol C1 to C3 obtained in Reference Example 2, Comparative Reference Example 1 and Comparative Reference Example 2 as Component C, poly(methylol)melamine derivative “Cohedur A” manufactured by Bayer (hereinafter, simply referred to as C4) and hexamethylenetetramine (hereinafter, simply referred to as C5) were further added in the amounts described in Table 1, respectively, followed by kneading for 1.5 minutes with controlling the temperature of the rubber so as to become 100° C. or less. The unvulcanized rubber composition discharged from the Banbury mixer was transferred to an open mill, and was molded by extrusion to a sheet form at a rubber temperature of 80 to 100° C. After that, the test pieces for thermal stability test and dynamic viscoelasticity test were prepared and the test pieces of the vulcanized rubber composition were obtained by vulcanizing at 150° C. for 25 minutes.

Scorching resistance test and dynamic viscoelasticity test were carried out by using the rubber compositions obtained according to the following methods. The results are shown in Table 2.

### <Scorching Resistance Test>

According to JIS K-6300, the scorching time T5 (minute) at a measuring temperature of 135° C. was measured. The longer T5 is, the better the processability is.

### <Dynamic Viscoelasticity Test>

The loss factors at 60° C. were measured at the initial strain of 10%, the dynamic strain of 0.5% and the frequency of Hz using a dynamic viscoelasticity spectrometer F-III manufactured by Iwamoto Seisakusho Co., Ltd. The smaller the loss factor is, the smaller the evolution of heat caused by the cyclic deformation of the materials (hysteresis loss) is.

TABLE 1

| | Condensation | | | Average degree |
|---|---|---|---|---|
| | product | | | of |
| | (Parts by weight) | Y² | Y⁴ | polymerization |
| Example 1 | C1 (1) | 0.44 | 4.81 | 1.59 |
| Reference | C2 (1) | 0.14 | 4.88 | 1.64 |
| Example 1 | | | | |
| Reference | C3 (1) | 0.61 | 4.19 | 1.94 |
| Example 2 | | | | |
| Reference | C4 ⁽*¹⁾ (2) | 1.06 | 3.97 | 1.14 |
| Example 3 | | | | |
| Reference | C5 ⁽*²⁾ (1) | — | — | — |
| Example 4 | | | | |

⁽*¹⁾ Poly (methylol)melamine derivative described in JP S58-147444 A (content of the active components: 50% by weight)
⁽*²⁾ It is described in Example of JP H9-87425 A.

TABLE 2

| | Scorching | |
|---|---|---|
| | resistance T5 | |
| | (minute) | Loss factor |
| Example 1 | 39.0 | 0.118 |
| Reference | 39.7 | 0.126 |
| Example 1 | | |
| Reference | 31.1 | 0.134 |
| Example 2 | | |
| Reference | 30.5 | 0.131 |
| Example 3 | | |
| Reference | 29.8 | 0.119 |
| Example 4 | | |

### Example 2

A belt is obtained by coating steel cords plated with brass with the rubber composition obtained in Example 1. An unvulcanized tire is molded by using the obtained belt according to a conventional process and the unvulcanized tire obtained is heated and pressurized in a vulcanizer to obtain a tire.

### Example 3

The extruding processing of the rubber composition obtained in Example 1 is conducted to prepare a rubber composition having a shape fitting on the carcass shape and it is applied up and down carcass fiber cord made of polyester to obtain a carcass. An unvulcanized tire is molded by using the obtained carcass according to a conventional process and the unvulcanized tire obtained is heated and pressurized in a vulcanizer to obtain a tire.

### INDUSTRIAL APPLICABILITY

According to the present invention, a rubber composition giving rubber products having a good processability on producing the rubber products such as improvement of scorching resistance and a good dynamic viscoelasticity such as reduction of loss factor can be provided.

1. A rubber composition comprising:
(A) 100 parts by weight of a rubber component mainly containing at least one rubber selected from the group consisting of natural rubber and/or isoprene rubber,
(B) 0.5 to 3 parts by weight of a condensation product of resorcin and a ketone, and
(C) 0.5 to 2 parts by weight of a condensation product of melamine, formaldehyde and methanol wherein the ratio of methylol groups to melamine structures is 0.35 to 0.55 and the average degree of polymerization is 1.2 to 1.6.

2. The rubber composition according to claim 1, wherein the ketone of the condensation product of resorcin and a ketone is acetone.

3. The rubber composition according to claim 1 or 2, wherein the ratio of methoxy groups to melamine structures of the condensation product of melamine, formaldehyde and methanol is 4.3 to 4.9.

4. The rubber composition according to claim 1, which further comprises 5 to 15 parts by weight of hydrous silica and 45 to 60 parts by weight of carbon black per 100 parts by weight of the rubber component (A).

5. A belt comprising a steel cord coated with the rubber composition according to claim 1.

6. A carcass comprising a carcass fiber cord covered with the rubber composition according to claim 1.

7. A captread or undertread comprising the rubber composition according to claim 1.

8. A pneumatic tire produced by using the rubber composition according to claim 1.
